(19) United States
(12) Patent Application Publication
(10) Pub. No.: US 2014/0226351 A1
(43) Pub. Date: Aug. 14, 2014

(54) ILLUMINATED LOGO SUNSHADE

(71) Applicants: Everardo A. Hernandez, Shelby Township, MI (US); Aidano C. Nascimento, Rochester, MI (US); David W. Whitehead, Rochester Hills, MI (US); Jeffrey T. Rodgers, Beverly Hills, MI (US)

(72) Inventors: Everardo A. Hernandez, Shelby Township, MI (US); Aidano C. Nascimento, Rochester, MI (US); David W. Whitehead, Rochester Hills, MI (US); Jeffrey T. Rodgers, Beverly Hills, MI (US)

(21) Appl. No.: 14/179,654

(22) Filed: Feb. 13, 2014

Related U.S. Application Data
(60) Provisional application No. 61/764,074, filed on Feb. 13, 2013.

(51) Int. Cl. B60Q 3/02; B60J 7/00

(52) U.S. Cl. CPC B60Q 3/0213; B60J 7/0015
USPC 362/509

(57) ABSTRACT

A sunshade for use in a vehicle is provided including a core having at least one opening extending there through. A layer of material is positioned adjacent at least a first surface of the core. The sunshade also includes a light generation system arranged to direct light through the at least one opening.

### CROSS REFERENCE TO RELATED APPLICATIONS

This application claims the benefit of U.S. Provisional Application Ser. No. 61/764,074 filed Feb. 13, 2013, the contents of which are incorporated herein by reference thereto.

### BACKGROUND

Embodiments of the invention relate to a sunroof or moonroof system of a vehicle, and more particularly, to a movable sun shade of the sunroof or moonroof system.

Sunroofs are desirable features to many vehicle consumers. The sunroof is typically located above an occupant seating area, and as a result, may affect the available headroom to the occupants. Sunroofs typically move forward to rearward between a closed and an open position. The sunroof may be stored in the open position on the exterior of the vehicle, or alternatively, the sunroof may be stowed between the roof and a headliner of the passenger compartment.

Sun shades are commonly used with vehicle sunroofs to block sunlight when the sunroof is in the closed position. Because the sun shade is intended to block sunlight from entering into the interior of the vehicle, the sun shade has a generally solid construction that does not allow light to pass there through. Due to ongoing desires to improving the aesthetics within the passenger compartment of a vehicle, it is desirable to provide aesthetically pleasing, functional alternatives to conventional sun shades.

### SUMMARY OF THE INVENTION

According to one exemplary embodiment of the present invention, a sunshade for use in a vehicle is provided including a core having at least one opening extending there through. A layer of material is positioned adjacent at least a first surface of the core. The sunshade also includes a light generation system arranged to direct light through the at least one opening.

According to another embodiment of the invention, a sunshade for use in a vehicle is provided including a core having at least one opening extending through the thickness of the core to define a pattern. A layer of material is positioned adjacent at least a first surface of the core. Light from a light source is configured to illuminate the pattern such that the pattern is visible through the layer of material.

According to yet another embodiment of the invention, a sun shade for use in a vehicle is provided including a core having a pattern formed as an indentation on a first surface thereof. A layer of material is positioned adjacent at least the first surface of the core. A light emitting mechanism is arranged within the indentation of the first surface. The light emitting mechanism is configured to illuminate the image such that the pattern is visible through the layer of material.

### BRIEF DESCRIPTION OF THE DRAWINGS

The present invention will now be described, by way of example only, with reference to the accompanying drawings in which:

FIG. 1 is a partial perspective view of a vehicle having a sliding roof system;

FIG. 2 is cross-sectional view of an exemplary sun shade of the sliding roof system shown in FIG. 1;

FIG. 3 is a partial cross-sectional view of another exemplary sun shade of the sliding roof system shown in FIG. 1;

FIG. 4 is a bottom view of a sun shade according to an embodiment of the invention;

FIG. 5 is a top view of a core of a sun shade including a light generation system according to an embodiment of the invention;

FIG. 6 is a top view of a core of a sun shade including a light generation system according to an embodiment of the invention;

FIG. 7 is a bottom view of a core of a sun shade including a light generation system according to an embodiment of the invention;

FIG. 8 is a bottom view of a core of a sun shade including a light generation system according to an embodiment of the invention.

The above-described and other features and advantages of the present application will be appreciated and understood by those skilled in the art from the following detailed description, drawings, and appended claims.

### DETAILED DESCRIPTION OF EXEMPLARY EMBODIMENTS

In accordance with exemplary embodiments of the present invention, a sun shade having a light generation system for displaying an image visible to an occupant in a vehicle is provided. In one embodiment, the light generation system uses natural light to illuminate the image. In another embodiment, the light generation system uses an electrical light source to illuminate the image.

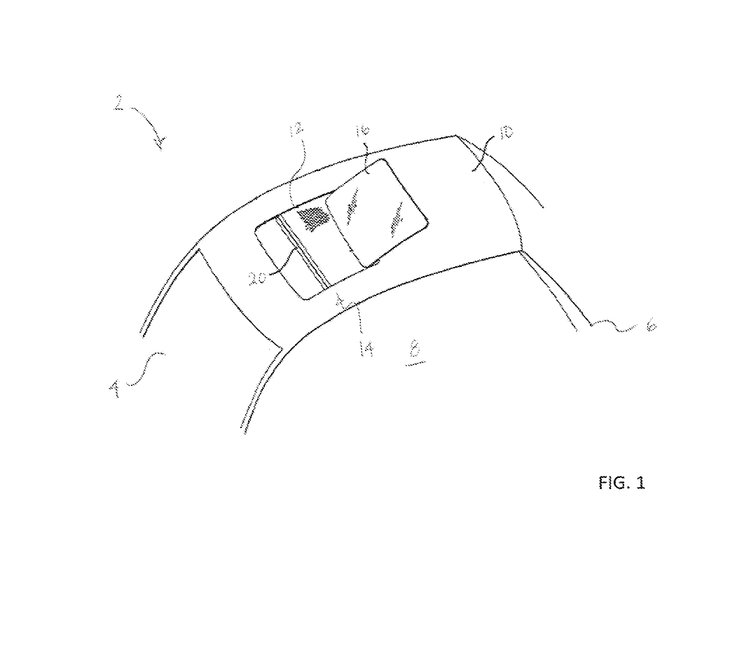

Referring now to FIG. 1, the roof 10 of a vehicle 2 having an opening 12 is illustrated. Although, the vehicle illustrated in FIG. 1 is an automobile and is used as one non-limiting example, it is also understood that this invention may be applicable to any type of vehicle requiring or configured to have a sun shade, non-limiting examples include but are not limited to aircraft, marine or water vessels, boats, recreational vehicles, land based vehicles, trucks, trains, SUVs, airplanes, jets, etc. A cover 16 of a sliding roof system 14 is associated with the opening 12 and is configured to move between a closed position where the cover 16 closes the opening 12, and an open position illustrated in the FIG. A sun shade 20 is arranged underneath the cover 16 and the opening 12. The sun shade 20 is movable generally forward and backward toward the front 4 and rear 6, respectively, of the vehicle 2. If the sun shade 20 is retracted, or moved completely toward the rear 6 of the vehicle 2, the opening 12 will be entirely exposed and sunlight can enter the vehicle interior space 8 freely. If the sun shade 20 is extended, or moved completely toward the front 4 of the vehicle 2, the opening 12 is covered by the sun shade 20, thereby blocking sunlight from entering the interior space 8 of the vehicle 2. Although the sun shade 20 is described as part of a sliding roof system 14 in the illustrated and disclosed non-limiting embodiment, other configurations, such as adjacent another opening, a non-sliding roof window, or side window of a vehicle 2 for example, are within the scope of the present invention.

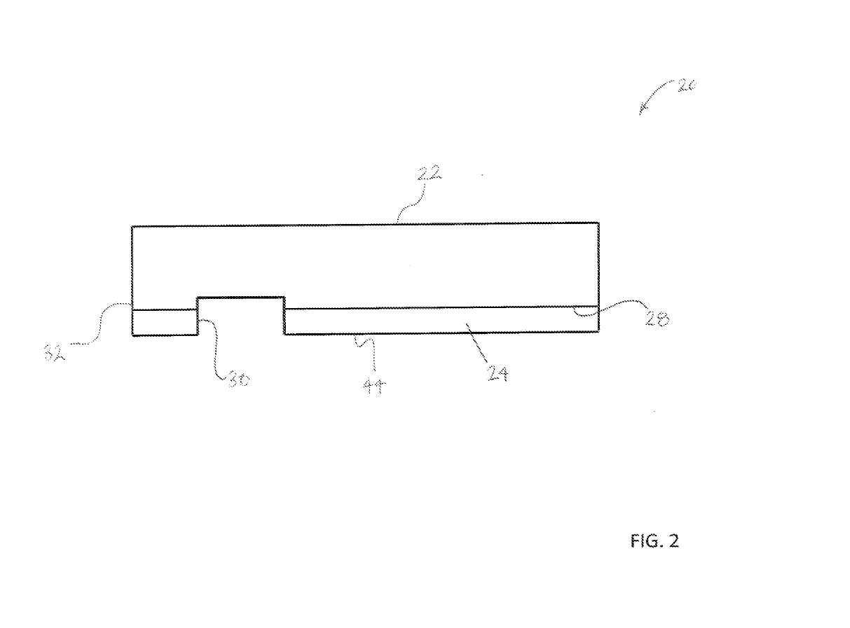

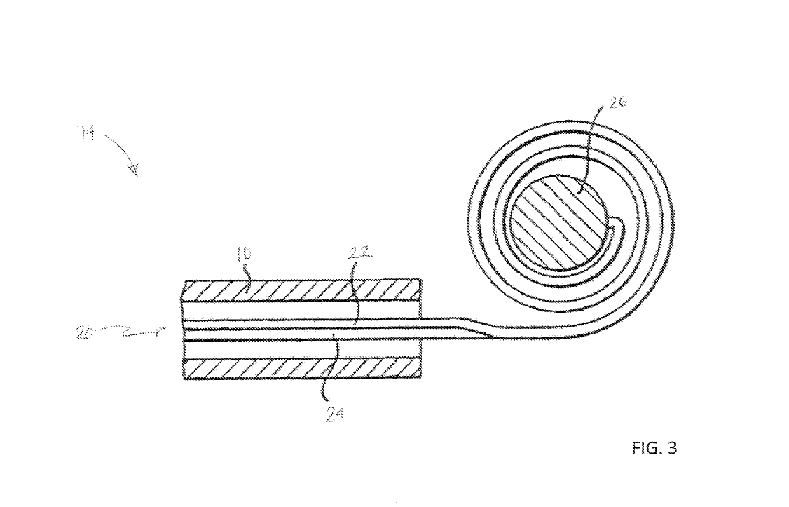

The sun shade 20 generally includes a core 22 at least partially surrounded by an aesthetically pleasing material 24. In embodiments where the sun shade 20 translates substantially linearly relative to the opening 12, the core 22 is generally made from a rigid material. One non-limiting example is illustrated in FIG. 2. Alternatively, in embodiments where the sun shade 20 coils about a winding body 26, the core 22 of the sun shade 20 is a substantially flexible material (FIG. 3). For example, the core 22 may be made from a substrate, such as polyurethane or cardboard for example, and the aesthetically pleasing material 24 may consist of a fabric arranged to cover a surface 28 of the core 22 adjacent the interior space 8 of the vehicle 2. In the illustrated embodiment, a handle 30 is disposed adjacent the front edge 32 of the sun shade 20 and is configured to be gripped by a vehicle occupant to translate the sun shade 20 between the retracted and extended positions (FIG. 2).

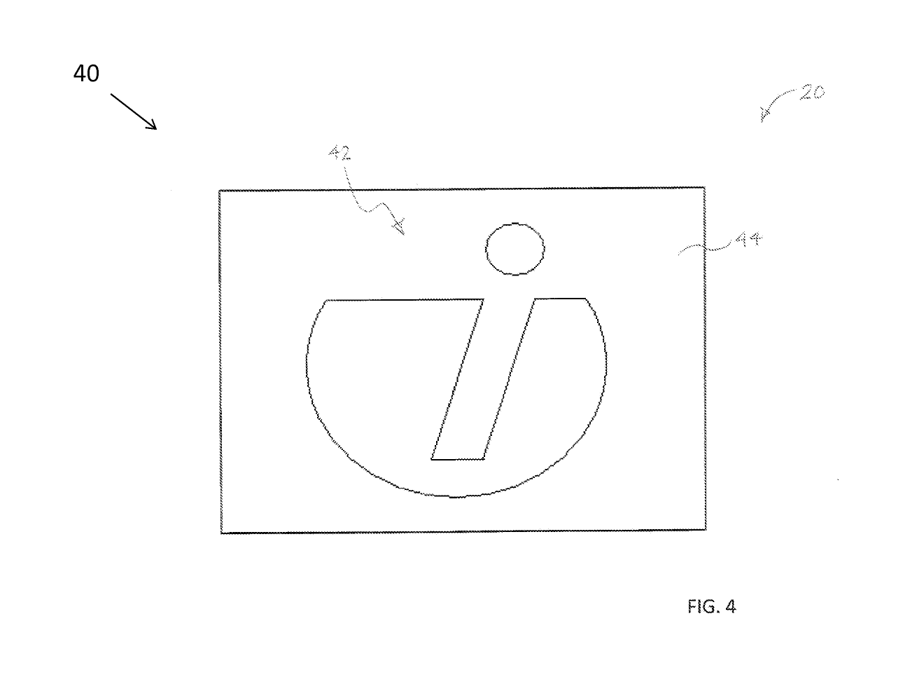

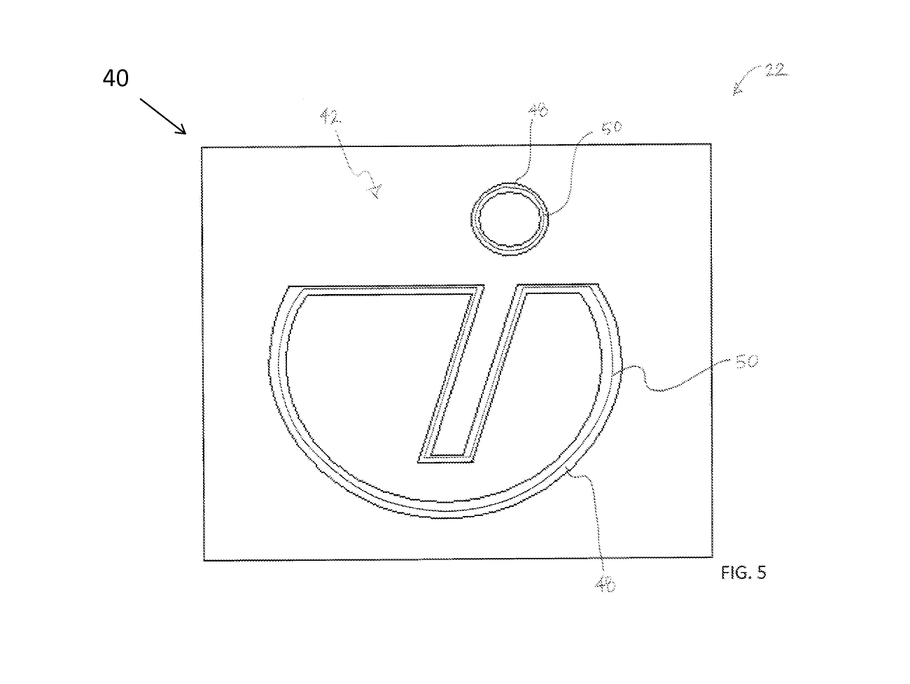

Referring now to FIGS. 4-8, the sun shade 20 includes a light generation system 40 configured to illuminate an image or pattern 42 of the sun shade 20 so that the image 42 is visible from the interior space 8 of the vehicle 2. An exemplary image 42 of the sun shade 20, visible from the interior 8 of the vehicle 2 is shown in FIG. 4. In one embodiment, the image 42 to be illuminated is formed into the core 22 of the sun shade 20 by removing or cutting away portions to create openings 48 extending through the thickness of the core 22 (see FIGS. 5 & 6). When the sun shade 20 is in an extended or closed position, external ambient light, such as natural light passing through the substantially transparent cover 16 of the vehicle roof 10 for example, may transmit through the openings 48 in the core 22. As the light passes through the openings 48 in the core 22, the image 42 formed therein is illuminated. In one embodiment, the aesthetically pleasing material 24 at least partially allows light to pass there through. As a result, the light illuminating the image 42 in the core 22 appears on the exterior surface 44 of the material 24, visible to an occupant within the interior space 8 of the vehicle 2.

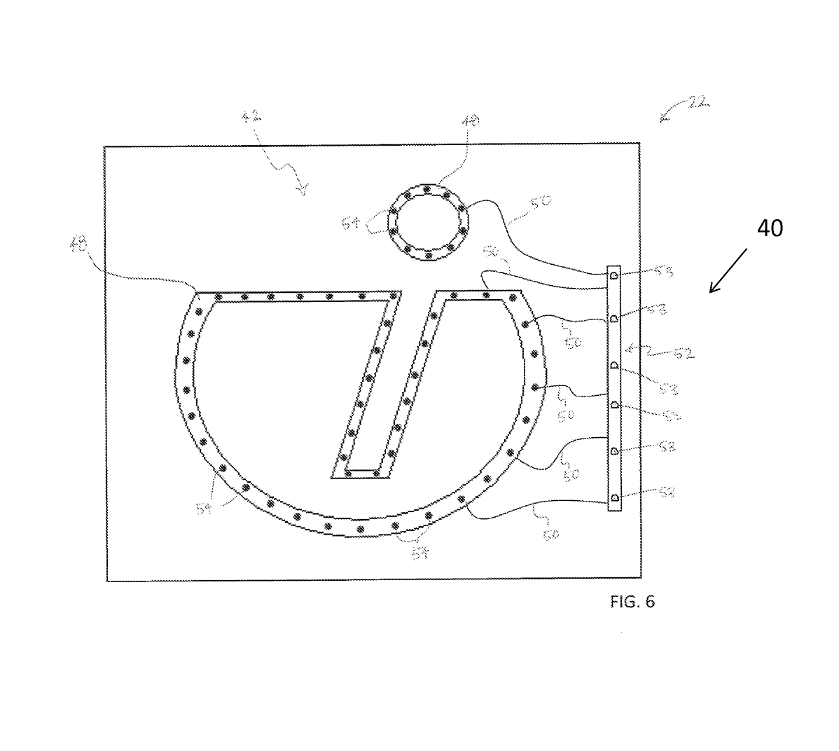

In another embodiment shown in FIGS. 5 and 6, one or more light emitting mechanisms 50 are coupled to a light source 52, such as an LED light or a light pipe for example. These light emitting mechanisms 50 are positioned within the openings 48 formed in the core 22 such that the light emitting mechanisms 50 are generally arranged about the periphery of the image 42. Exemplary light emitting mechanisms 50 include, but are not limited to, fiber optic cables, strip lights and rope lights for example. As shown in FIG. 5, the light emitting mechanism 50 may be wound about the periphery of the image 42 such that light is emitted along the length of the light emitting mechanism 50. Alternatively, a plurality of light emitting mechanisms 50 may extend from a light source 52 toward the openings 48 formed in the core 22. As illustrated, the light source 52 includes six light emitting diodes (LEDs) 53; however, any number of LEDs or an alternative light source 52 may be used. The free ends 54 of the light emitting mechanisms 50 are positioned about the openings 48 that form the image 42 such that the light emitted from the plurality of free ends 54 illuminates the image 42, making it visible from the interior space 8 of the vehicle.

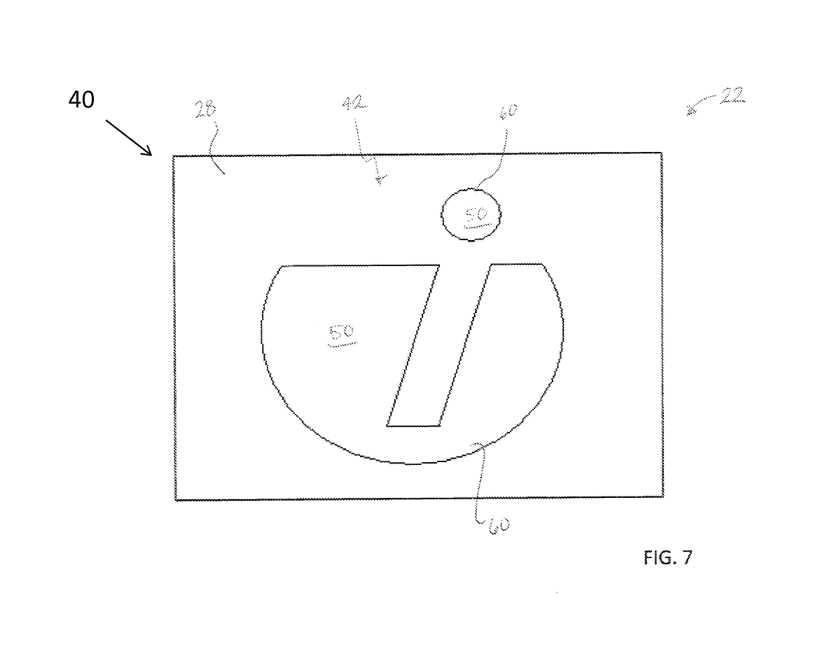

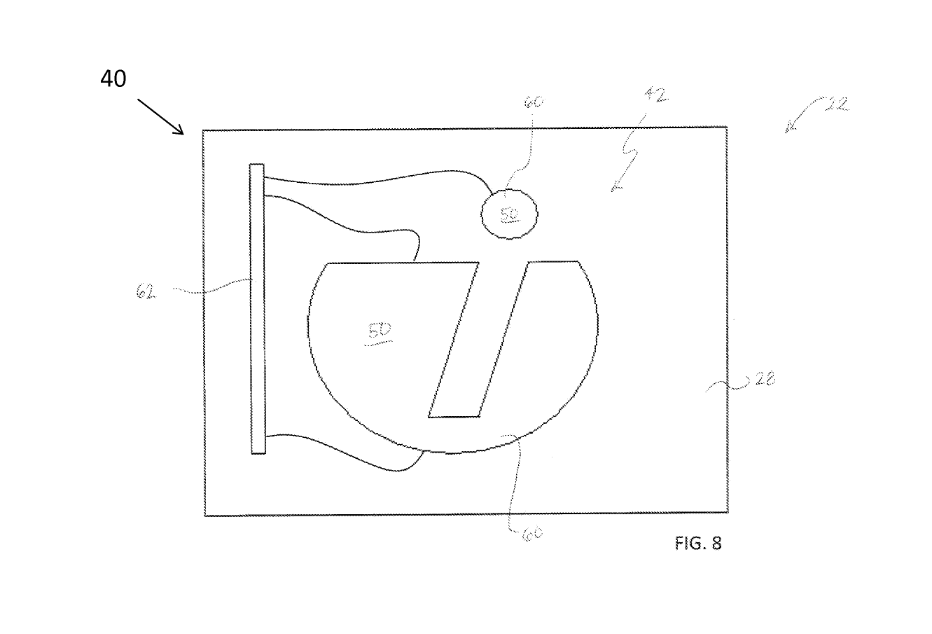

Referring now to FIGS. 7 and 8, another embodiment is shown where the image 42 may alternatively be formed as an indentation in the surface 28 of the core 22. In such instances, one or more light emitting mechanisms 50 are positioned within the indented portions 60 of the surface 28 between the core 22 and the aesthetically pleasing material 24. In one embodiment, the light emitting mechanism 50 includes a glow in the dark material, such as a tape or paint for example, configured to release stored light energy in the absence of ambient light (FIG. 7). In another embodiment illustrated in FIG. 8, the light emitting mechanism 50 positioned within the indented portion 60 of the surface 28 is an electroluminescent material. A selectively operable power source 62 is coupled to the electroluminescent light emitting material 50 such that when a current is applied to the electroluminescent light emitting material 50, a light is generated. In one embodiment, the power source 62 may be coupled to an electrical system of the vehicle 2, such as the lighting system for example.

Inclusion of the light generation system 40 in a sun shade 20, allows a desired image, logo, or pattern 42, to be illuminated, and therefore visible from the interior of the vehicle 2, whenever the sun shade 20 is in a closed or retracted position. By using natural light or light from an electrical light source, the image may be illuminated both day and night.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A sun shade for use in a vehicle, comprising:
a core having at least one opening extending there through;
a layer of material positioned adjacent at least a first surface of the core; and
a light generation system arranged to direct light through the at least one opening.

2. The sun shade according to claim 2, wherein the core includes a substrate material.

3. The sun shade according to claim 2, wherein the layer of material includes a fabric that allows light to pass at least partially there through.

4. A sun shade for use in a vehicle, comprising:
a core having at least one opening formed through a thickness of the core to define a pattern;
a layer of material positioned adjacent at least a first surface of the core; wherein light from a light source is configured to illuminate the pattern such that the pattern is visible through the layer of material.

5. The sun shade according to claim 4, further comprising at least one light emitting means coupled to the light source, the light emitting means being positioned within the at least one opening.

6. The sun shade according to claim 5, wherein the at least one light emitting means is a fiber optic cable.

7. The sun shade according to claim 6, wherein the fiber optic cable is wound generally about the periphery of the image and is configured to emit light along a length of the fiber optic cable.

8. The sun shade according to claim 5, wherein a free end of the at least one light emitting mechanism is positioned within the at least one opening about a periphery of the image.

9. The sun shade according to claim 5, wherein the light source is external, ambient light.

10. The sun shade according to claim 5, wherein the light source is an electrical light source.

11. A sun shade for use in a vehicle, comprising:
a core having a pattern formed as an indentation on a first surface thereof;
a layer of material positioned adjacent at least the first surface of the core; and
a light emitting mechanism arranged within the indentation of the first surface, the light emitting mechanism being configured to illuminate the image such that the pattern is visible through the layer of material.

12. The sun shade according to claim 11, wherein the light emitting mechanism is configured to illuminate the pattern in the absence of external, ambient light.

13. The sun shade according to claim 12, wherein the light emitting mechanism includes a glow in the dark material.

14. The sun shade according to claim 10, further comprising an electrical power source coupled to the light emitting mechanism.

15. The sun shade according to claim 14, wherein the light emitting mechanism is configured to illuminate the pattern when a current is applied to the light emitting material.

16. The sun shade according to claim 15, wherein the light emitting mechanism includes an electroluminescent material.

17. The sun shade according to claim 10, wherein the electrical power source is coupled to an electrical system of the vehicle such that activation of the electrical system similarly activates the electrical power source.

18. The sun shade according to claim 17, wherein the electrical power source is coupled to a lighting system of the vehicle.
